(19) United States
(12) Patent Application Publication
(10) Pub. No.: US 2025/0239056 A1
(43) Pub. Date: Jul. 24, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: TOMOKI TAMINATO, Kanagawa (JP)

(21) Appl. No.: 19/028,346

(22) Filed: Jan. 17, 2025

(30) Foreign Application Priority Data
Jan. 23, 2024 (JP) 2024-008107

(51) Int. Cl. G06V 10/774; G06F 16/55; G06V 10/40; G06V 10/82

(52) U.S. Cl. CPC G06V 10/774; G06F 16/55; G06V 10/40; G06V 10/82

(57) ABSTRACT

An information processing apparatus for training a model that identifies a category of an object included in an image includes at least one processor and at least one memory that is in communication with the at least one processor. The at least one memory stores instructions for causing the at least one processor and the at least one memory to acquire an attribute from the image, acquire information about a group of categories easily misidentified with each other under a specific attribute condition, generate a group including a plurality of categories when the model is trained based on the attribute and the information about the group, and train the model based on an identification result generated by identifying the category of the object included in the image using the model, and the group of the categories.

### BACKGROUND

### Field of the Disclosure

The present disclosure relates to an information processing apparatus, an information processing method, and a storage medium.

### Description of the Related Art

In recent years, in training a machine learning model (hereinbelow, referred to as a category classifier) for identifying a category, there has been discussed a technique of dividing learning target categories into several groups in advance and learning them to improve an identification rate of a subclass.

“Yu Li, Tao Wang, Bingyi Kang, Sheng Tang, Chunfeng Wang, Jintao Li, Jiashi Feng, ‘Overcoming Classifier Imbalance for Long-Tail Object Detection With Balanced Group Softmax’, Proceedings of the IEEE/CVF Conference on Computer Vision and Pattern Recognition (CVPR), 2020, pp. 10991-11000” discusses a method of dividing supervised data for training the category classifier into a group of a low occurrence frequency and a group of a high occurrence frequency, and calculating a loss function in training for each group to suppress the unbalance of the supervised data. Further, “Takumi Kobayashi, ‘Group Softmax Loss With Discriminative Feature Grouping’, Proceedings of the IEEE/CVF Winter Conference on Applications of Computer Vision (WACV), 2021, pp. 2615-2624” discusses a method of grouping categories based on a magnitude of likelihood of each category identified by a category classifier and improving the classification accuracy between misidentified categories by performing training using the grouped loss functions (Softmax function).

However, it is difficult to improve the classification accuracy between categories of objects that become easily misidentified under a specific condition such as a condition in which the size of the identification target is small. For example, there is a case where a small airplane in an image is easily misidentified as a bird, or a case where a dog in a low brightness image is easily misidentified as a cat. As described above, misidentification tends to occur under the specific condition.

### SUMMARY

Embodiments of the present disclosure are directed to a technique for improving an classification accuracy between categories of an object of which input data is easily misidentified under a specific condition.

According to an aspect of the present disclosure, an information processing apparatus for training a model that identifies a category of an object included in an image includes at least one processor and at least one memory that is in communication with the at least one processor. The at least one memory stores instructions for causing the at least one processor and the at least one memory to acquire an attribute from the image, acquire information about a group of categories easily misidentified with each other under a specific attribute condition, generate a group including a plurality of categories when the model is trained based on the attribute and the information about the group, and train the model based on an identification result generated by identifying the category of the object included in the image using the model, and the group of the categories.

Further features of various embodiments will become apparent from the following description of exemplary embodiments with reference to the attached drawings.

### BRIEF DESCRIPTION OF THE DRAWINGS

FIG. 1 is a block diagram illustrating an example of a hardware configuration of an information processing apparatus.

FIG. 2 is a block diagram illustrating an example of a functional configuration of the information processing apparatus.

FIG. 3 is a block diagram illustrating an example of a functional configuration of an attribute acquisition unit.

FIG. 4 is a block diagram illustrating an example of a functional configuration of a group generation unit.

FIGS. 5A and 5B are diagrams each illustrating a misidentification rate for a category.

FIG. 6 is a flowchart illustrating training processing of a category classifier.

FIG. 7 is a block diagram illustrating an example of a functional configuration of the information processing apparatus.

FIG. 8 is a block diagram illustrating an example of a functional configuration of an attribute acquisition unit.

FIG. 9 is a flowchart illustrating training processing of a category classifier.

FIG. 10 is a block diagram illustrating an example of a functional configuration of the information processing apparatus.

### DESCRIPTION OF THE EMBODIMENTS

Hereinbelow, exemplary embodiments of the present disclosure will be described with reference to the attached drawings.

In a first exemplary embodiment, a system for training a machine learning model (hereinbelow, referred to as a category classifier) for identifying a category of an object in an input image will be described. The system generates a group of categories to be used when training of the category classifier is performed using an attribute parameter acquired from the image, and trains the category classifier using the generated group. Input data may be a document or time-series data, and is not limited to the image.

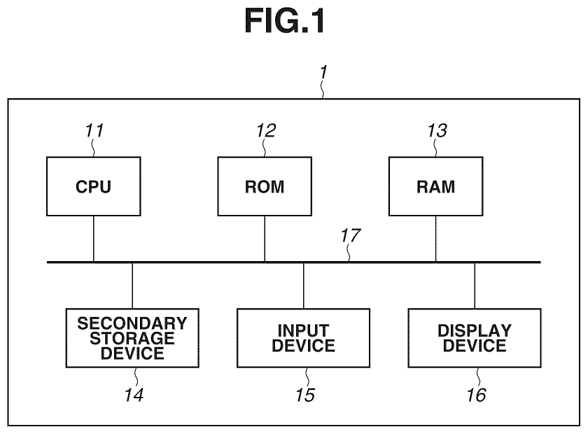

FIG. 1 is a block diagram illustrating an example of a hardware configuration of an information processing apparatus according to the present exemplary embodiment. An information processing apparatus 1 includes a central processing unit (CPU) 11, a read only memory (ROM) 12, a random access memory (RAM) 13, a secondary storage device 14, an input device 15, and a display device 16. These components are connected with each other via a connection bus 17. The CPU 11 controls the entire information processing apparatus 1. Processing in flowcharts described below is implemented by the CPU 11 executing a control program stored in the ROM 12 or the like. However, instead of or in conjunction with the CPU 11, a graphics processing unit (GPU) may be used.

The ROM 12 is a non-volatile memory to store a control program and various kinds of parameter data. The RAM 13 is a volatile memory to temporarily store images, a control program, and an execution result thereof. The secondary storage device 14 is a rewritable secondary storage device, such as a hard disk drive and a flash memory, to store various kinds of data used for implementing the flowcharts described below. For example, the secondary storage device 14 stores input data, a control program, a data set for training, and a processing result. These pieces of information are output to the RAM 13, and the CPU 11 uses the information to execute the control program.

The input device 15 is a keyboard, a mouse, a touch panel device, or the like to input various kinds of user's instructions. The display device 16 is a monitor or the like to display processing results and images.

In the present exemplary embodiment, it is assumed that the processing described below is implemented by software using the CPU 11. Also, a part of or all of the processing described below may be implemented by hardware. A dedicated circuit such as an application specific integrated circuit (ASIC), and a processor such as a reconfigurable processor and a digital signal processor (DSP) can be used as the hardware. Further, the information processing apparatus 1 may include a communication unit to communicate with an external apparatus and may acquire the input data, the control program, the data set for training, and the like from the external apparatus via the communication unit, and output the processing result to the external apparatus via the communication unit.

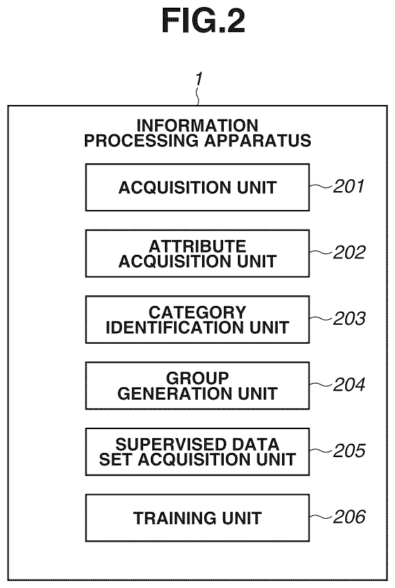

FIG. 2 is a block diagram illustrating an example of a functional configuration of the information processing apparatus 1 according to the present exemplary embodiment. The information processing apparatus 1 includes an acquisition unit 201, an attribute acquisition unit 202, a category identification unit 203, a group generation unit 204, a supervised data set acquisition unit 205, and a training unit 206. The function of each functional unit illustrated in FIG. 2 is implemented by the CPU 11 executing the control program stored in the ROM 12.

The acquisition unit 201 acquires an image from an external apparatus or the secondary storage device 14.

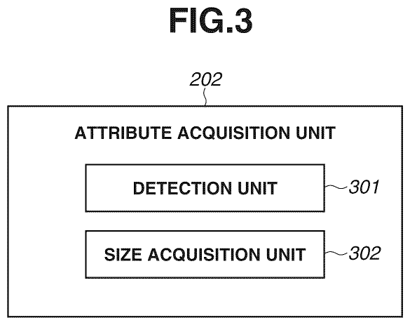

The attribute acquisition unit 202 acquires an attribute parameter from the image. In the present exemplary embodiment, an attribute is a size of an object region in the image. The attribute parameter is a value of the attribute and is a value indicating the size of the object region in the present exemplary embodiment. Details of the function of the attribute acquisition unit 202 will be described below with reference to FIG. 3.

The category identification unit 203 identifies a category of an object in an image. In the present exemplary embodiment, categories are consecutively numbered from 1 to N, and the category identification unit 203 classifies objects into N categories (i.e., a first category to an N-th category). The category identification unit 203 includes a category classifier for classifying the objects in the image into one of the first to N-th categories.

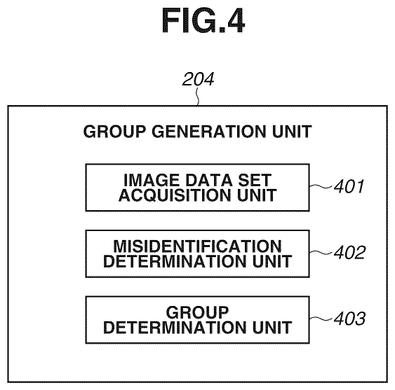

The group generation unit 204 generates information about a group of categories easily misidentified under a specific condition by aggregating sets of the attribute parameter and a category identification result of each image. Details of a function of the group generation unit 204 will be described below with reference to FIG. 4.

The supervised data set acquisition unit 205 acquires a supervised data set for the first to N-th categories prepared in advance, from an external apparatus or the secondary storage device 14.

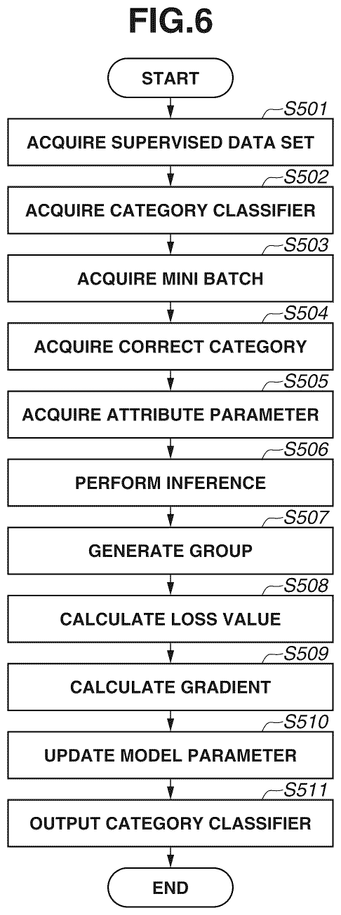

The training unit 206 trains the category classifier included in the category identification unit 203 using the supervised data set as input data. Details of processing performed by the training unit 206 will be described below with reference to FIG. 6.

FIG. 3 is a block diagram illustrating an example of a functional configuration of the attribute acquisition unit 202 according to the present exemplary embodiment. The attribute acquisition unit 202 includes a detection unit 301 and a size acquisition unit 302.

The detection unit 301 detects an object region in the image acquired by the acquisition unit 201. The object region may be rectangular surrounding an object, or may be a region within a closed curve surrounding an object boundary. Examples of a method of detecting the object region include a method of using a learning model that has been trained in advance to detect a specific category region, as discussed in “Zhi Tian, Chunhua Shen, Hao Chen, Tong He, ‘FCOS: Fully Convolutional One-Stage Object Detection’, Proceedings of the IEEE/CVF International Conference on Computer Vision (ICCV), 2019, pp. 9627-9636.”

The size acquisition unit 302 acquires a size from the object region detected by the detection unit 301. In a case where the object region is rectangular, the size may be the width or the height, or the area of the rectangle.

In a case where the object region is the region within the closed curve surrounding the object boundary, the size may be the number of counts of the pixels in the region.

As described above, the attribute acquisition unit 202 acquires the size of the object region in the image, which is the attribute parameter according to the present exemplary embodiment.

FIG. 4 is a block diagram illustrating an example of a functional configuration of the group generation unit 204 according to the present exemplary embodiment. The group generation unit 204 includes an image data set acquisition unit 401, a misidentification determination unit 402, and a group determination unit 403.

The image data set acquisition unit 401 acquires an image data set consisting of images of N categories identifiable by the category identification unit 203 and information about categories of objects in the images from an external apparatus or the secondary storage device 14. The image data set may be a supervised data set for training the category classifier of the category identification unit 203 described below or may be an image data set prepared separately therefrom.

The misidentification determination unit 402 acquires an attribute parameter (in the present exemplary embodiment, the size of the object region in the image) for each image in the image data set using the attribute acquisition unit 202. Further, the misidentification determination unit 402 acquires a category identification result of the object in each image in the image data set using the category identification unit 203. Herein, the category identification result indicates, for example, a likelihood for each of the N categories into which the category classifier can classify the objects. From the category identification result, it can be determined that the category with the highest likelihood is most likely the category of the object in the image.

The misidentification determination unit 402 aggregates the set of the attribute parameter and the category identification result for each image in the image data set to determine a set of the attribute parameter (object size) and the category that the category classifier tends to misclassify. The misidentification determination unit 402 classifies the object size into predetermined ranges (e.g., a large size range, a middle size range, and a small size range) and, for each size range, counts, for an image belonging to the first category, the number of occurrences of misidentified category when the category classifier misidentifies an image belonging to the first category as an image belonging to a category other than the first category. Then, the misidentification determination unit 402 calculates a probability (misidentification rate) of misidentifying the image belonging to the first category as an image belonging to the misidentified category for each misidentified category. Similarly, the calculation is repeated for images belonging to the second category to the N-th category, and the misidentification determination unit 402 counts the number of occurrences of the misidentified category for each size range to calculate the misidentification rate.

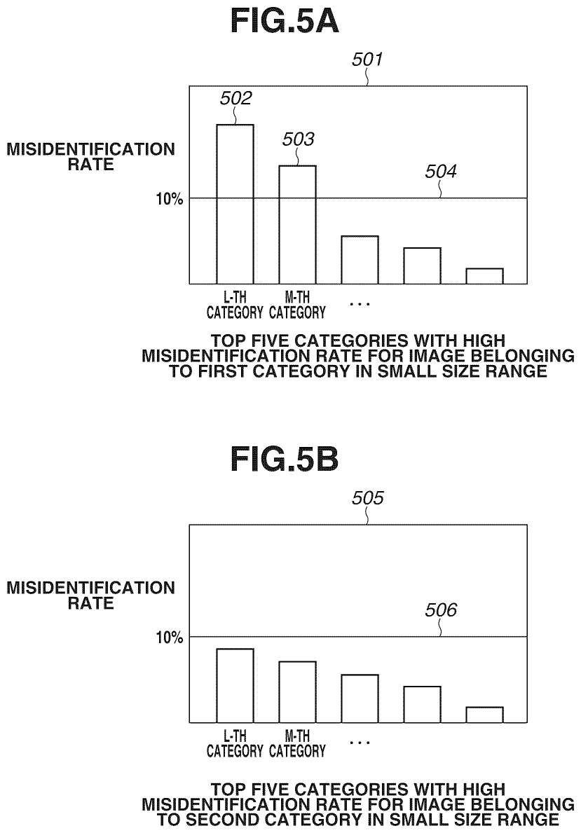

The group determination unit 403 determines a group of categories based on the misidentification rates calculated by the misidentification determination unit 402. FIG. 5A is an example of a graph illustrating a misidentification rate for each category into which the image belonging to the first category is misidentified in the small size range. In the example in FIG. 5A, a misidentification rate 502 of a L-th category and a misidentification rate 503 of a M-th category exceed a predetermined threshold value 504 (e.g., 10%) of the misidentification rate. In this case, the group determination unit 403 adds the L-th and M-th categories to the group for the first category in the attribute of the small size range. In this way, the group determination unit 403 generates the group including the categories that are easily misidentified (in this case, the L-th and M-th categories) for the first category under the specific attribute condition (herein, the small size range). In the present exemplary embodiment, while the group determination unit 403 determines the category having the misidentification rate exceeding the threshold value to be the easily misidentified category, but the method to determine the easily misidentified category is not limited to the method of using the misidentification rate as described above.

In a similar manner, the group determination unit 403 determines a group for each of the second category to the N-th category in the small size range. FIG. 5B is an example of a graph illustrating a misidentification rate for each category into which the image belonging to the second category is misidentified in the small size range. In the example in FIG. 5B, there is no category with the misidentification rate exceeding a predetermined threshold value 506 (e.g., 10%). In this case, the group determination unit 403 does not generate a group for the second category in the small size range.

In a similar manner, the group determination unit 403 generates the group of easily misidentified categories for each of the first to the N-th categories for the middle and large size ranges. The information about the group of categories generated by the group generation unit 204 is held in the secondary storage device 14 or the like.

FIG. 6 is a flowchart illustrating training processing of the category classifier according to the present exemplary embodiment. The training unit 206 trains the category classifier using the supervised data set for the first to N-th categories prepared in advance, and the information about the group of categories generated by the group generation unit 204. The information about the group of categories generated by the group generation unit 204 is, for example, data including a set of a category and other categories easily misidentified as the category under a specific attribute condition (e.g., the object is in a small size). The information about the group of categories generated by the group generation unit 204 is obtained by aggregating the set of the attribute parameter of the image for each category in the image data set, and the category identification result.

In step S501, the training unit 206 acquires a supervised data set for training a category classifier, using the supervised data set acquisition unit 205. The supervised data set may be stored in the secondary storage device 14 or the like. The supervised data set acquisition unit 205 may acquire the supervised data set from the secondary storage device 14, or from an external apparatus.

In step S502, the training unit 206 acquires the category classifier included in the category identification unit 203. In the present exemplary embodiment, the category classifier is a machine learning model for identifying a category of an object in an image. The machine learning model is assumed to be a multi-layered neural network model. However, it is not limited to the multi-layered neural network model, and a known machine learning model such as random forests and Adaptive Boosting (AdaBoost) may be used. Model parameters of the category classifier is stored in the secondary storage device 14 or the like.

In step S503, the training unit 206 acquires a mini batch from the supervised data set acquired in step S501. The mini batch is data including one or more images to be input to the category classifier.

In step S504, the training unit 206 acquires a correct category corresponding to each of the images in the mini batch.

In step S505, the training unit 206 acquires an attribute parameter for each of the images in the mini batch using the attribute acquisition unit 202. In the present exemplary embodiment, the training unit 206 acquires the size of the object region in each of the images.

In addition, in a case where information indicating the size of the object region in the image is included in the supervised data set in advance, the training unit 206 may acquire the information. The attribute acquisition unit 202 functions as an attribute acquisition unit.

In step S506, the training unit 206 performs inference processing on each of the images in the mini batch using the category identification unit 203. More specifically, the training unit 206 calculates a likelihood (logit) for each category of the first to N-th categories obtained by inputting each of the images into the category classifier. In this way, a category identification result for an object in each of the images is obtained. The category identification result includes the likelihoods (logits) for all the categories. The category identification unit 203 functions as a category identification unit.

In step S507, first, the training unit 206 sets one of the images in the mini batch as a target. The training unit 206 acquires the information about the group of categories generated by the group generation unit 204 from the secondary storage device 14 or the like. The training unit 206 functions as a group acquisition unit. Then, the training unit 206 generates a group in a case where there is a category easily misidentified under a specific attribute condition with respect to the correct category (acquired in step S504) of the target image and where the attribute parameter (acquired in step S505) of the target image satisfies the specific attribute condition. The training unit 206 functions as a group generation unit. The generated group includes one or more categories that are easily misidentified as the correct category. In this way, the training unit 206 generates the group of categories for each of the images in the mini batch. Thus, the training unit 206 switches the group to be applied to the target image when a loss value (loss function) is calculated in the next step, using the correct category of each of the images in the mini batch and the attribute parameter thereof. On the other hand, the training unit 206 generates no group in a case where the above-described condition is not satisfied. For example, the training unit 206 generates no group in a case where the attribute parameter (acquired in step S505) of the target image does not satisfy the specific attribute condition. In other words, the training unit 206 performs control whether to generate a group based on the correct category and the attribute parameter.

In step S508, the training unit 206 calculates the loss value (loss function) using the category identification result of each of the images in the mini batch and the group of categories. In the present exemplary embodiment, for the calculation of the loss value, a group softmax function used in “Yu Li, Tao Wang, Bingyi Kang, Sheng Tang, Chunfeng Wang, Jintao Li, Jiashi Feng, ‘Overcoming Classifier Imbalance for Long-Tail Object Detection With Balanced Group Softmax’, Proceedings of the IEEE/CVF Conference on Computer Vision and Pattern Recognition (CVPR), 2020, pp. 10991-11000” or “Takumi Kobayashi, ‘Group Softmax Loss With Discriminative Feature Grouping’, Proceedings of the IEEE/CVF Winter Conference on Applications of Computer Vision (WACV), 2021, pp. 2615-2624” is used. While the training unit 206 uses the sum of the likelihoods of all the categories by a normal softmax function in a case where no group is generated, the training unit 206 calculates the loss value by using the sum of the likelihoods of the categories in the group by a group softmax function in a case where the group is generated. By applying the group softmax function, the training is performed so that characteristics between the grouped categories are separated, and it is possible to easily suppress misidentification between the grouped categories.

In addition, similar to the method of applying the softmax function between the grouped categories, the sum of the grouped categories may be used in a known loss function obtained by expanding the softmax function, such as SphereFace and ArcFace. Further, when the loss is calculated, not only a value of the group softmax function, but also a value obtained by multiplying a value of the normal softmax function by a certain weight may be added. In this way, while the classification accuracy between all the categories is maintained, it is possible to suppress the misidentification of the category that tends to occur under the specific attribute condition (e.g., the object size is small).

In step S509, the training unit 206 calculates a gradient by applying an error backpropagation method to the loss calculated in step S508, to obtain an update amount of the model parameter of the category classifier.

In step S510, the training unit 206 updates the model parameter of the category classifier. More specifically, a learning method of a known multi-layered neural network can be applied thereto, and a detailed description thereof is omitted.

In step S511, the training unit 206 outputs the category classifier with the model parameter updated, to the category identification unit 203.

The training unit 206 determines the model parameters of the category classifier by repeating the processing from steps S501 to S511 described above until the loss value and the classification accuracy converge. Then, the processing of the flowchart ends.

The group generation unit 204 may regenerate the group depending on learning progress using the correct category (acquired in step S504), the attribute parameter (acquired in step S505), and the inference result (acquired in step S506) of each of the images in the mini batch. The training unit 206 may apply a new group to the input data from the next learning.

According to the first exemplary embodiment described above, by training the category classifier using the group of categories easily misidentified under the specific attribute condition, it is possible to improve the classification accuracy between the categories under the specific attribute condition.

In a second exemplary embodiment, a method of performing training efficiently by converting an image to correct an attribute parameter, and increasing the number of images with a specific attribute parameter will be described. In the present exemplary embodiment, descriptions of portions identical with the first exemplary embodiment are omitted, and differences from the first exemplary embodiment will be mainly described.

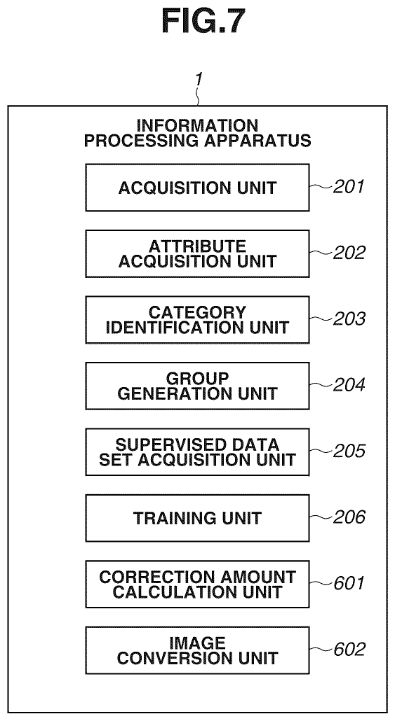

FIG. 7 is a block diagram illustrating an example of a functional configuration of an information processing apparatus 1 according to the present exemplary embodiment. The functional configuration illustrated in FIG. 7 is different from the functional configuration illustrated in FIG. 2 in that the functional configuration in FIG. 7 includes a correction amount calculation unit 601 and an image conversion unit 602.

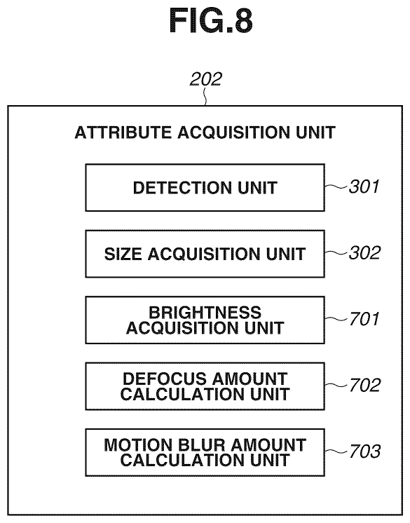

Further, in the present exemplary embodiment, the attribute acquisition unit 202 acquires, as attribute parameters, not only the size of the object region in the image, but also a brightness value, a defocus amount, a motion blur amount, and the like, of the image. Details of the function of the attribute acquisition unit 202 will be described below with reference to FIG. 8.

The correction amount calculation unit 601 calculates a correction amount for each of the attribute parameters acquired by the attribute acquisition unit 202.

The image conversion unit 602 converts the image so as to have the attribute parameters each corrected using the correction amount calculated by the correction amount calculation unit 601.

FIG. 8 is a block diagram illustrating an example of a functional configuration of the attribute acquisition unit 202 according to the present exemplary embodiment. The functional configuration in FIG. 8 is different from the functional configuration in FIG. 3 in that the functional configuration in FIG. 8 includes a brightness acquisition unit 701, a defocus amount calculation unit 702, and a motion blur amount calculation unit 703.

The brightness acquisition unit 701 acquires a brightness value of an image. For example, the brightness acquisition unit 701 acquires a brightness value in a commonly used YUV color space. Further, the attribute parameter may be an average value of brightness values in the image, or may be an average value of brightness values within the object region detected by the detection unit 301.

The defocus amount calculation unit 702 estimates a defocus amount of an object in an image. Examples of a method for estimating the defocus amount include a method of using a machine learning model (hereinbelow, referred to as an defocus amount estimator) for estimating the defocus amount. The defocus amount estimator performs learning by preparing supervised data, for example, including a set of an image defocused by applying a Gaussian blur to an image of an object with no defocus, and a strength of the Gaussian blur within the object region in the image. Further, at a time of inference, the defocus amount estimator estimates the strength of the Gaussian blur within the object region.

The motion blur amount calculation unit 703 estimates a motion blur amount of an object in an image. Examples of a method for estimating the motion blur amount include, similar to the defocus amount calculation unit 702, a method of using a machine learning model (hereinbelow, referred to as a motion blur amount estimator) for estimating the motion blur amount. The motion blur amount estimator performs learning by preparing supervised data, for example, including a set of an image obtained by applying a motion blur filter to an image of an object with no motion blur, and a strength of the filter. Further, at a time of inference, the motion blur amount estimator estimates the strength of the motion blur filter within the object region.

In the present exemplary embodiment, the group generation unit 204 generates information about a group of categories easily misidentified under a specific attribute condition by aggregating sets of an attribute parameter and a category identification result of each image. As in the present exemplary embodiment, in a case where aggregation is performed using a plurality of attribute parameters, the specific attribute condition may be a condition of a combination of the plurality of attribute parameters, not only a condition of one attribute parameter. For example, the condition may be a condition obtained by combining the size of an object region (e.g., small size range) and the brightness value (e.g., low brightness).

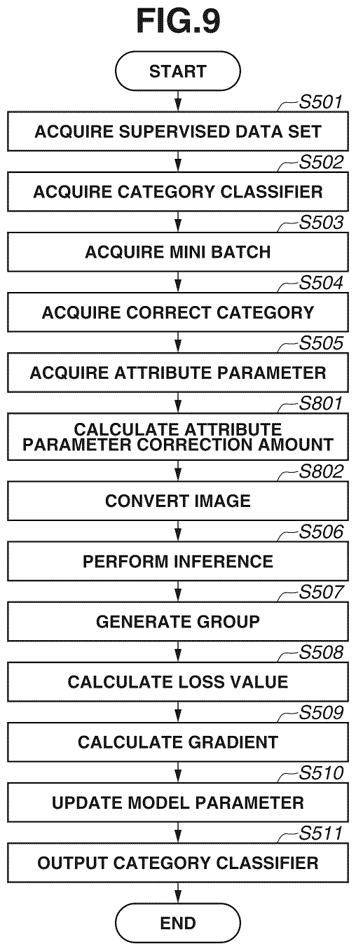

FIG. 9 is a flowchart illustrating training processing of a category classifier according to the present exemplary embodiment. The flowchart in FIG. 9 is different from the flowchart in FIG. 6 mainly in that processing in steps S801 and S802 is executed between processing in steps S505 and S506. Hereinbelow, a processing step different from that in FIG. 6 will be described, and a description of ag similar processing step is omitted.

In step S505, the training unit 206 acquires the attribute parameter of each of the images in the mini batch acquired in step S503 using the attribute acquisition unit 202. In the case of the present exemplary embodiment, the training unit 206 acquires not only the size of the object region in the image, but also the magnitude of a brightness value, a defocus amount, and a motion blur amount. In a case where the supervised data set includes, in advance, information indicating the size of the object region in the image and the magnitude of the brightness value, the defocus amount, and the motion blur amount, the training unit 206 may acquire the information.

In step S801, the training unit 206 calculates a correction amount for the attribute parameter acquired in step S505, using the correction amount calculation unit 601. Examples of a method of calculating the correction amount by the correction amount calculation unit 601 include a method of using statistics of the attribute parameter in the supervised data set. For example, the correction amount calculation unit 601 acquires the attribute parameter for each of the images in the supervised data set using the attribute acquisition unit 202, divides the acquired attribute parameter into predetermined ranges, and calculates an occurrence frequency for each divided range.

Then, the correction amount calculation unit 601 calculates the correction amount such that the attribute parameter of the image in the mini batch acquired in step S503 becomes an attribute parameter within a range where the occurrence frequency is low with a certain probability when the image is converted in step S802. For example, in a case where the occurrence frequency is low in the small size range, the correction amount calculation unit 601 calculates the correction amount for the size of the object region (e.g., a resize value such that the object is in the small size range) so that the image in the small size range appears with a probability exceeding the occurrence frequency. The processing step for calculating the correction amount in step S801 may be executed each time an image is acquired in step S503 or may be executed with a probability set in advance.

For example, in a case where the occurrence frequency in the small size range is 3% using the original supervised data set, to increase the occurrence frequency to 30%, the correction amount calculation unit 601 calculates the correction amount for the attribute parameter so that the range of the attribute parameter of the acquired image in the mini batch becomes the small size range with the probability of 30%. Further, regarding other parameters such as the brightness value, the defocus amount, and the motion blur amount, the correction amount calculation unit 601 similarly calculates the correction amount for the attribute parameter so that the range of the attribute parameter with a low occurrence frequency appears with a certain probability. In this way, in the present exemplary embodiment, the group generation unit 204 generates the group using the supervised data set obtained by increasing the ratio of the attribute parameter in the range with the low occurrence frequency.

As a method other than the above-described method using the statistics of the attribute parameters of the supervised data set, there may be a method of calculating a correction amount of the attribute parameter so that the attribute parameter becomes the attribute parameter of the group of the easily misidentified categories acquired by the group generation unit 204. For example, in a case where a group with a range of brightness values associated therewith is generated, the correction amount calculation unit 601 calculates a correction amount so that the brightness value of the acquired image falls within the range of the brightness values associated with the group.

In step S802, the training unit 206 applies the correction amount for the attribute parameter acquired in step S801 to the image in the mini batch acquired in step S503 to perform conversion using the image conversion unit 602.

In a case where the attribute parameter is the size of the object region, the image is resized based on the correction amount. In a case where the attribute parameter is the brightness value, the brightness value of the image in the YUV color space is converted. In a case where the attribute parameter is the defocus amount and the motion blur amount, the image is converted by adding the correction amount to each of the defocus amount of the image and the strength of the motion blur amount.

Then, the processing steps in step S506 and the subsequent steps are executed.

In step S507, the training unit 206 generates a group for each of the images in the mini batch based on the corrected attribute parameter value using the group generation unit 204. Then, in step S508, when the correct category of the target image is the first category, and in a case where there is a category that is easily misidentified as the first category under a specific attribute condition and the attribute parameter of the target image satisfies the specific attribute condition, the training unit 206 generates a group thereof. Further, when the correct category of the target image is the M-th category, and in a case where the M-th category is easily misidentified as the first category in the small size range and the size of the object region in the target image is in the small size range, the training unit 206 generates a group to include the first category and the M-th category. Further, when the correct category of the target image is the L-th category, in a case where the L-th category is easily misidentified as the first category at a low brightness value and the target image has a low brightness value, the training unit 206 generates a group to include the first category and the L-th category. Not only the condition of one attribute parameter, but also a condition of a combination of a plurality of attribute parameters may be used. Then, in step S508, the training unit 206 calculates a loss value by applying a group softmax function to each group generated in the mini batch and summing results thereof.

The training unit 206 determines the model parameters of the category classifier by repeating the processing in steps S501 to S511 described above until the loss value and the classification accuracy converge. Then, the processing of the flowchart ends.

The group generation unit 204 may determine to exclude a misidentified category from the group by resolving the misidentification between the categories under the specific attribute condition based on a result of the misidentification calculated using the category classifier that is being trained. Then the training unit 206 may use a new group to the input data from the next training.

According to the second exemplary embodiment described above, it is possible to increase the efficiency of the training and improve the classification accuracy between the categories by adjusting the occurrence frequency of the image with the condition of the specific attribute parameter, generating the group of easily misidentified categories, and training the category classifier.

In a third exemplary embodiment, a system that identifies a category of an object in an image, generates a category group based on the identified category and the attribute parameter of the image, and applies an analysis task depending on the group will be described. The analysis task is prepared for each of the identified categories. More specifically, as the analysis task prepared for a category of a person, there is a task of detecting a joint point of a person, and as the analysis task prepared for a category of an animal, there is a task of detecting a face of an animal. In the present exemplary embodiment, descriptions of portions identical with the first exemplary embodiment are omitted, and differences from the first exemplary embodiment will be mainly described.

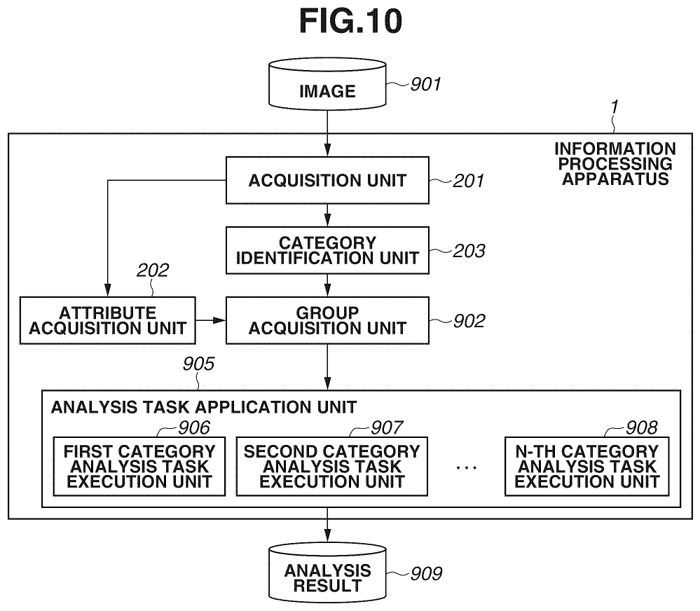

FIG. 10 is a block diagram illustrating an example of a functional configuration of an information processing apparatus 1 according to the present exemplary embodiment. As illustrated in FIG. 10, the information processing apparatus 1 according to the present exemplary embodiment includes the acquisition unit 201, the attribute acquisition unit 202, and the category identification unit 203, which are similar to those in the first exemplary embodiment.

The information processing apparatus 1 according to the present exemplary embodiment further includes an analysis task application unit 905. The analysis task application unit 905 includes a first category analysis task execution unit 906, a second category analysis task execution unit 907, . . . , and an N-th category analysis task execution unit 908. Assume that the category identification unit 203 includes a category classifier trained by the method according to the first exemplary embodiment or the second exemplary embodiment. Further, a group acquisition unit 902 acquires information about a group of categories from the secondary storage device 14 or the like. The information about the group of categories is information about a group of categories easily misidentified under a specific attribute condition, generated using the category classifier included in the category identification unit 203.

In the present exemplary embodiment, the acquisition unit 201 acquires an image 901 with an object of an unknown category captured therein. Next, the attribute acquisition unit 202 acquires an attribute parameter of the image 901. In this case, for purpose of clarity of the description, the size of the object region in the image 901 is estimated and acquired using the detection unit 301 and the size acquisition unit 302.

The category identification unit 203 identifies the category of the object in the captured image. The group acquisition unit 902 acquires information about a group including the identified category in a specific size range of a region using the acquired size of the object region and the identified category. In this case, the size of the region falls into either a large size range or a small size range.

Assume that the acquired size of the object region belongs to the small size range, and the identified category is an n-th category. In this case, the analysis task application unit 905 applies the n-th category analysis task execution unit to the input data to output an analysis result 909 in a case where there is no group including a category other than the n-th category with respect to the n-th category. On the other hand, in a case where there is a group including an m-th category with respect to the n-th category when the attribute parameter is in the small size range, there is a possibility that the n-th category identified by the category identification unit 203 is a misidentified category, and actually is the m-th category.

Accordingly, the analysis task application unit 905 applies not only the analysis task execution unit of the n-th category, but also the analysis task execution unit of the m-th category to the input data. More specifically, the analysis task application unit 905 applies to the input data the analysis task execution unit of the other category belonging to the group in a case where there is a group to which the attribute condition to which the acquired attribute parameter belongs is given and including the identified category. There is a case where the desired analysis result 909 can be acquired by applying the plurality of analysis tasks to the input data in consideration of the possibility of misidentification. Also, in a case where there is a group to which the attribute condition to which the acquired attribute parameter belongs is given and including the identified category, the analysis task application unit 905 may operate not to apply any of the analysis task execution units to the input data. In this way, the execution of the erroneous analysis task can be avoided.

According to the third exemplary embodiment described above, it is possible to apply a more appropriate analysis task to the input data even if there is a category easily misidentified under a specific attribute condition.

While the present disclosure has described exemplary embodiments, the above-described exemplary embodiments are merely examples of realizing the present disclosure, and shall not be construed as limiting the technical scope of the present disclosure. In other words, embodiments of the present disclosure can be realized in diverse forms as long as they are in accordance with the technological thought or main features of the present disclosure.

The present disclosure can also be realized by processing of supplying a program for implementing one or more functions of the above-described exemplary embodiments to a system or an apparatus via a network or a storage medium, and reading and executing the program by one or more processors in a computer of the system or the apparatus. Further, the present disclosure can also be realized by a circuit (e.g., an application specific integrated circuit (ASIC)) that can implement one or more functions.

The disclosure of the above-described exemplary embodiments includes the flowing configurations, a method, and a storage medium.

According to the present disclosure, it is possible to improve the classification accuracy between the categories that are easily misidentified when input data is under a specific condition.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-008107, which was filed on Jan. 23, 2024 and which is hereby incorporated by reference herein in its entirety.

What is claimed is:

1. An information processing apparatus for training a model that identifies a category of an object included in an image, the information processing apparatus comprising:
at least one processor; and
at least one memory that is in communication with the at least one processor,
wherein the at least one memory stores instructions for causing the at least one processor and the at least one memory to:
acquire an attribute from the image;
acquire information about a group of categories easily misidentified with each other under a specific attribute condition;
generate a group including a plurality of categories when the model is trained based on the attribute and the information about the group; and
train the model based on an identification result generated by identifying the category of the object included in the image using the model, and the group of the categories.

2. The information processing apparatus according to claim 1, wherein in a case where the attribute satisfies the specific attribute condition, the group includes a correct category of the object and one or more categories to be easily misidentified as the correct category under the specific attribute condition.

3. The information processing apparatus according to claim 1, wherein the at least one memory further stores instructions for causing the at least one processor and the at least one memory to aggregate misidentification rates of the categories for attributes for a data set of each of the categories to acquire the information about the group.

4. The information processing apparatus according to claim 1, wherein the at least one memory further stores instructions for causing the at least one processor and the at least one memory to:
convert the image so as to correct the attribute acquired from the image,
identify the category of the object included in the converted image, and
generate the group based on the corrected attribute.

5. The information processing apparatus according to claim 4, wherein the at least one memory further stores instructions for causing the at least one processor and the at least one memory to calculate a correction amount of the attribute using statistics of the attribute of the data set of each category to be a target of learning.

6. The information processing apparatus according to claim 5, wherein the at least one memory further stores instructions for causing the at least one processor and the at least one memory to:
acquire information about the group of the categories easily misidentified with each other under the specific attribute condition, and
calculate the correction amount of the attribute so that the attribute acquired from the image satisfies the specific attribute condition.

7. The information processing apparatus according to claim 1, wherein the attribute is a size of an object region in the image.

8. The information processing apparatus according to claim 1, wherein the attribute is brightness of the image.

9. The information processing apparatus according to claim 1, wherein the attribute is a motion blur in the image.

10. The information processing apparatus according to claim 1, wherein the attribute is a defocus in the image.

11. The information processing apparatus according to claim 1, wherein the at least one memory further stores instructions for causing the at least one processor and the at least one memory to reduce a loss by applying a loss function to the identification result of a category belonging to the group.

12. The information processing apparatus according to claim 1, wherein the at least one memory further stores instructions for causing the at least one processor and the at least one memory to:
control whether to generate the group based on the attribute,
in a case where the group is generated, apply a loss function to a category belonging to the group, and
in a case where the group is not generated, apply a loss function to all the categories.

13. An information processing apparatus for applying an analysis task for each category to an input image, the information processing apparatus comprising:
at least one processor; and
at least one memory that is in communication with the at least one processor,
wherein the at least one memory stores instructions for causing the at least one processor and the at least one memory to:
acquire an attribute from the input image;
identify a category of an object included in the input image;
acquire information about a group of categories easily misidentified with each other under a specific attribute condition; and
apply the analysis task to the input image based on the attribute, the identified category, and the information of the group.

14. The information processing apparatus according to claim 13, wherein the at least one memory further stores instructions for causing the at least one processor and the at least one memory to, in a case where the attribute satisfies the specific attribute condition and a first category, which is the identified category, belongs to the group, apply, to the input image, an analysis task for the first category and an analysis task for a category that is other than the first category and that belongs to the group.

15. The information processing apparatus according to claim 13, wherein the at least one memory further stores instructions for causing the at least one processor and the at least one memory to, in a case where the attribute satisfies the specific attribute condition, a first category, which is the identified category, belongs to the group, and a category other than the first category belongs to the group, not apply the analysis task to the input image.

16. An information processing method for training a model that identifies a category of an object included in an image, the information processing method comprising:
acquiring an attribute from the image;
acquiring information about a group of categories easily misidentified with each other under a specific attribute condition;
generating a group including a plurality of categories when the model is trained based on the acquired attribute and the acquired information about the group; and
training the model based on an identification result of identifying the category of the object included in the image using the model, and the generated group of the categories.

17. A non-transitory computer-readable storage medium storing a computer-executable program for causing a computer to perform the method according to claim 16.
